(19) United States
(12) Patent Application Publication
(10) Pub. No.: US 2026/0089217 A1
(43) Pub. Date: Mar. 26, 2026

(54) LARGE MODEL-BASED SYSTEMS AND METHODS OF INTERNET OF THINGS (IOT) FOR EMERGENCY REGULATION OF WATER SUPPLY PIPELINE NETWORKS IN SMART CITIES

(71) Applicant: CHENGDU QINCHUAN IOT TECHNOLOGY CO., LTD., Chengdu (CN)

(72) Inventor: Hanshu SHAO, Chengdu (CN)

(73) Assignee: CHENGDU QINCHUAN IOT TECHNOLOGY CO., LTD., Chengdu (CN)

(21) Appl. No.: 19/404,075

(22) Filed: Dec. 1, 2025

(30) Foreign Application Priority Data
Jul. 28, 2025 (CN) 202511055915.7

(51) Int. Cl. H04L 67/12; G06Q 50/06; G06Q 50/26; G16Y 10/35; G16Y 20/10; G16Y 20/30; G16Y 40/10; G16Y 40/20; G16Y 40/35

(52) U.S. Cl. CPC H04L 67/12; G16Y 10/35; G16Y 20/10; G16Y 20/30; G16Y 40/10; G16Y 40/20; G16Y 40/35; G06Q 50/06; G06Q 50/26

(57) ABSTRACT

Provide are a large model-based system and method of Internet of Things (IoT) for emergency regulation of a water supply pipeline network in a smart city. The system comprises a government regulation management platform, a government regulation sensing network platform, a government regulation object platform, a water company sensing network platform, and a smart water device object platform. The government regulation management platform is configured to: determine a time-series flow rate corresponding to each of a plurality of water pipeline node groups; determine a water and soil loss coefficient corresponding to each of one or more target regions based on the time-series flow rate; generate, based on the one or more water and soil loss coefficients, a temporary control parameter through a parameter generation model; and control an opening level of a valve corresponding to the one or more target regions based on the temporary control parameter.

### CROSS-REFERENCE TO RELATED APPLICATIONS

This application claims priority to Chinese Patent Application No. 202511055915.7, filed on Jul. 28, 2025, the entire contents of which are incorporated herein by reference.

### TECHNICAL FIELD

The present disclosure relates to the field of urban water pipeline monitoring, and in particular, to large model-based systems and methods of Internet of Things (IoT) for emergency regulation of water supply pipeline networks in smart cities.

### BACKGROUND

Water leakage may occur in urban water supply pipeline networks due to factors such as aging and corrosion, external damage, or the like. Since the water leakage is rather concealed and its destructive effect is relatively low in a short period of time, it is easy to be overlooked. In some regions, prolonged water leakage leads to water and soil loss, resulting in underground cavities and eventual ground collapse. In addition, the water leakage can trigger secondary disasters such as traffic congestion, damage to devices related to urban lifelines, or the like, thus posing safety risks.

Therefore, it is desirable to provide a large model-based system and method of Internet of Things (IoT) for emergency regulation of a water supply pipeline network in a smart city, which enable real-time monitoring and intelligent control of urban water distribution and drainage networks, thereby effectively reducing water and soil loss and water resource wastage.

### SUMMARY

One or more embodiments of the present disclosure provide a large model-based system of Internet of Things (IoT) for emergency regulation of a water supply pipeline network in a smart city, comprising a government regulation management platform, a government regulation sensing network platform, a government regulation object platform, a water company sensing network platform, a smart water device object platform, wherein the government regulation object platform includes a water company management platform; the smart water device object platform includes a monitoring device and at least one adjustment device; the government regulation management platform is configured to: determine a time-series flow rate corresponding to each of a plurality of water pipeline node groups based on water flow features of a plurality of water pipeline nodes in the water supply pipeline network; determine a water and soil loss coefficient corresponding to each of one or more target regions based on the time-series flow rate; generate, based on the water and soil loss coefficient, a temporary control parameter through a parameter generation model, the parameter generation model being a machine learning model; and control an opening level of each of one or more valves corresponding to the one or more target regions based on the temporary control parameter.

One or more embodiments of the present disclosure provide a method for emergency regulation of a water supply pipeline network in a smart city, executed by a government regulation management platform of a large model based system of Internet of Things (IoT) for emergency regulation of the water supply pipeline network in the smart city, the method comprising: determining a time-series flow rate corresponding to each of a plurality of water pipeline node groups based on water flow features of a plurality of water pipeline nodes in the water supply pipeline network; determining a water and soil loss coefficient corresponding to each of one or more target regions based on the time-series flow rate; generating, based on the water and soil loss coefficient, a temporary control parameter through a parameter generation model, the parameter generation model being a machine learning model; and controlling an opening level of each of one or more valves corresponding to the one or more target regions based on the temporary control parameter.

One or more embodiments of the present disclosure provide a non-transitory computer-readable storage medium, the storage medium storing computer instructions, wherein when reading the computer instructions in the storage medium, a computer executes the method for emergency regulation of the water supply pipeline network in the smart city provided in the present disclosure.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, where like reference numerals represent similar structures throughout the several views of the drawings, and wherein:

FIG. 1 is a block diagram illustrating an exemplary platform structure of a large model-based system of Internet of Things (IoT) for emergency regulation of a water supply pipeline network in a smart city according to some embodiments of the present disclosure;

FIG. 2 is a flowchart illustrating an exemplary process of emergency regulation of a water supply pipeline network in a smart city according to some embodiments of the present disclosure;

FIG. 3 is a schematic diagram illustrating an exemplary coefficient generation model according to some embodiments of the present disclosure; and

FIG. 4 is a schematic diagram illustrating an exemplary process of generating a temporary control parameter according to some embodiments of the present disclosure.

### DETAILED DESCRIPTION

The following description is presented to enable any person skilled in the art to make and use the present disclosure and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including” when used in this disclosure, specify the presence of stated features, integers, steps, operations, elements, and/or components, but do not preclude the presence or addition of one or more other features, integers, steps, operations, elements, components, and/or groups thereof.

It will be understood that the terms “system,” “engine,” “unit,” “module,” and/or “block” used herein are one method to distinguish different components, elements, parts, sections, or assemblies of different levels in ascending order. However, the terms may be displaced by another expression if they achieve the same purpose.

It will be understood that, although the terms “first,” “second,” “third,” etc., may be used herein to describe various elements, these elements should not be limited by these terms. These terms are only used to distinguish one element from another. For example, a first element could be termed a second element, and, similarly, a second element could be termed a first element, without departing from the scope of exemplary embodiments of the present disclosure.

The flowcharts used in the present disclosure illustrate operations that systems implement according to some embodiments in the present disclosure. It is to be expressly understood, the operations of the flowchart may be implemented not in order. Conversely, the operations may be implemented in an inverted order, or simultaneously. Moreover, one or more other operations may be added to the flowcharts. One or more operations may be removed from the flowcharts.

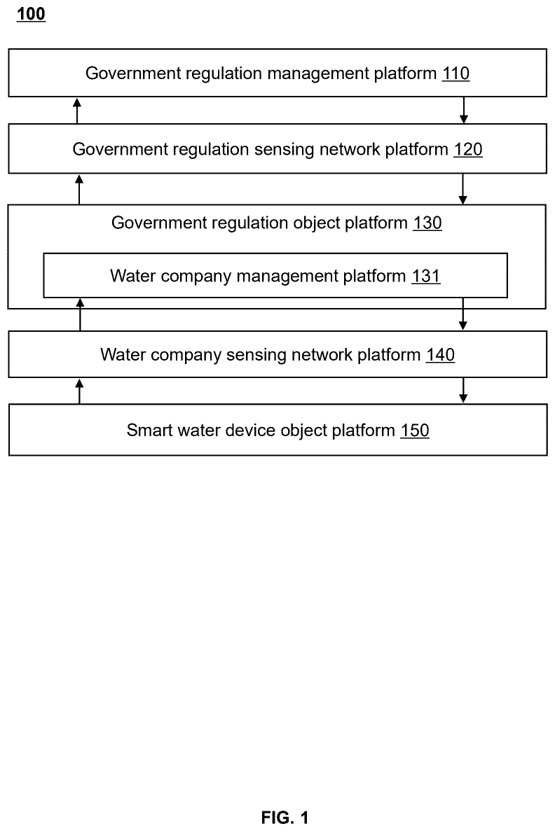

FIG. 1 is a block diagram illustrating an exemplary platform structure of a large model-based system of Internet of Things (IoT) for emergency regulation of a water supply pipeline network in a smart city according to some embodiments of the present disclosure.

In some embodiments, as shown in FIG. 1, a large model-based system 100 of Internet of Things (IoT) for emergency regulation of a water supply pipeline network in a smart city (hereinafter referred to as the system 100) may include a government regulation management platform 110, a government regulation sensing network platform 120, a government regulation object platform 130, a water company sensing network platform 140, and an smart water device object platform 150.

The government regulation management platform refers to a platform for the regulation and safety management of the water supply pipeline network. The water supply pipeline network may be a pipeline network used to transport and distribute water resources.

In some embodiments, the government regulation management platform may be configured in a processor and/or a server. The government regulation management platform may include a database. The database refers to a database for storing regulatory data. For example, the database may be configured to store data related to the water supply pipeline network, a parameter generation model, or the like.

In some embodiments, the government regulation management platform is configured to determine a time-series flow rate corresponding to each of a plurality of water pipeline node groups based on water flow features of a plurality of water pipeline nodes in the water supply pipeline network, and determine one or more water and soil loss coefficients corresponding to each of one or more target regions based on the time-series flow rate. The government regulation management platform may be further configured to generate, based on the water and soil loss coefficient, a temporary control parameter through the parameter generation model, and control an opening level of each of one or more valves corresponding to the one or more target regions based on the temporary control parameter.

The government regulation sensing network platform refers to a functional platform that manages sensing communications for the government. In some embodiments, the government regulation sensing network platform may be configured as a communication device and/or a gateway.

In some embodiments, the government regulation sensing network platform may interact with the government regulation management platform and the government regulation object platform.

The government regulation object platform refers to an information processing platform configured to regulate regulation objects related to the water supply pipeline network. In some embodiments, the government regulation object platform may include a water company management platform 131.

The water company management platform refers to an integrated platform for managing water company information. In some embodiments, the water company management platform may be configured as a processor and/or a server.

The water company sensing network platform refers to an integrated platform for managing water company sensing information. In some embodiments, the water company sensing network platform may be configured as a communication device and/or a gateway.

In some embodiments, the water company sensing network platform may interact with the water company management platform and the smart water device object platform.

The smart water device object platform refers to a functional platform for sensing information generation and control information execution. In some embodiments, the smart water device object platform includes a monitoring device and at least one adjustment device arranged in the water supply pipeline network.

The monitoring device refers to a device related to monitoring and recording an operational status of the water supply pipeline network. In some embodiments, the monitoring device may include a water flow sensor, etc. The water flow sensor may obtain the water flow features of the plurality of water pipeline nodes. The monitoring device may be installed at any feasible location in a pipeline corresponding to the water pipeline node, such as at a starting end of the pipeline or inside the pipeline, etc.

An adjustment device refers to a device for controlling and regulating a water flow, etc., in the water supply pipeline network. In some embodiments, the adjustment device may include a valve, a water supply pump, a user device, or the like. The user device refers to a device that controls the use of water at a user end, for example, a green irrigation system in a city, etc.

In some embodiments, the smart water device object platform further includes a detection robot. The detection robot refers to a machine for detecting soil information of locations in which the water pipeline node groups are located. For example, the detection robot may detect a soil feature (e.g., a soil density, a soil water content, a soil viscosity, etc.), etc.

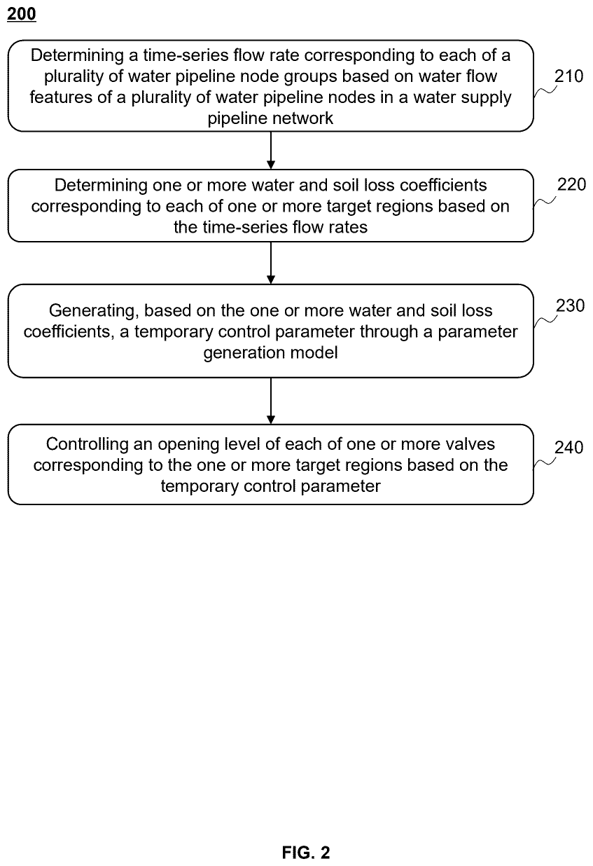

More descriptions regarding the above platforms may be found in FIG. 2 to FIG. 4 and relevant descriptions thereof.

In some embodiments, the system 100 can establish an information operation closed-loop among various functional platforms. Under the unified management of the government regulation management platform, these platforms operate in a coordinated and regulated manner, achieving smart and information-based emergency regulation of the water supply pipeline network in the smart city.

It should be noted that the above descriptions of the large model-based system of Internet of Things (IoT) for emergency regulation of a water supply pipeline network in a smart city and its platforms are provided for illustrative purposes only and shall not limit the scope of the present disclosure to the described embodiments. It may be understood by those skilled in the art that, upon comprehending the system's principles, various platforms may be arbitrarily combined or configured as subsystems connected with other platforms without departing from these principles.

FIG. 2 is a flowchart illustrating an exemplary process of emergency regulation of a water supply pipeline network in a smart city according to some embodiments of the present disclosure. As shown in FIG. 2, process 200 includes the following operations. In some embodiments, process 200 may be performed by the government regulation management platform 110.

Operation 210, determining a time-series flow rate corresponding to each of a plurality of water pipeline node groups based on water flow features of a plurality of water pipeline nodes in the water supply pipeline network.

The water pipeline node refers to a section of water pipeline in the water supply pipeline network. In some embodiments, the plurality of water pipeline nodes in the water supply pipeline network may be preset by a technician based on historical experience and stored in a database.

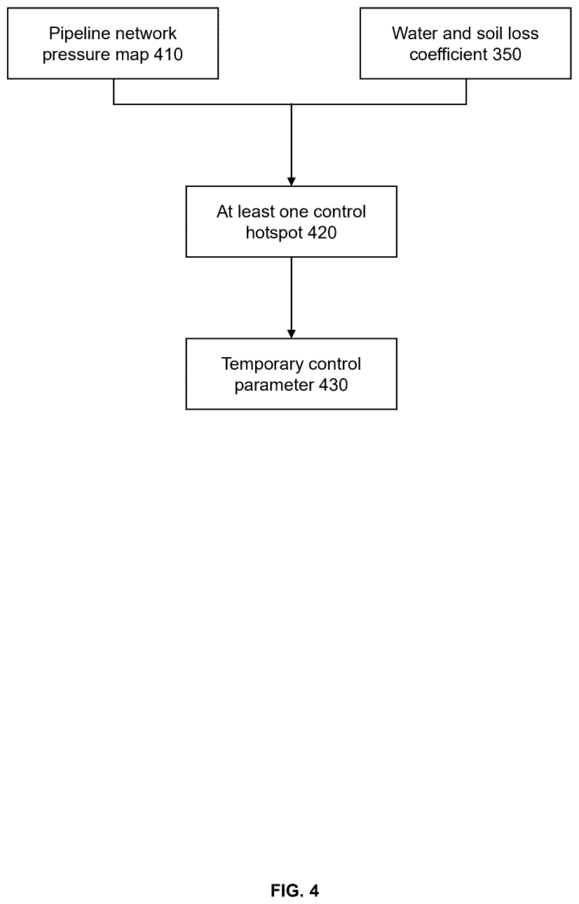

The water flow feature of a water pipeline node refers to data associated with a water flow rate at the water pipeline node. In some embodiments, the water flow feature of a water pipeline node may include the water flow rate at the water pipeline node. The water flow rate at the water pipeline node may be acquired by a water flow sensor in the monitoring device. More descriptions regarding the monitoring device may be found in FIG. 4 and relevant descriptions thereof.

A water pipeline node group refers to a collection of one or more water pipeline nodes. In some embodiments, the government regulation management platform may classify one or more water pipeline nodes adjacent to one another on a same water flow path into a water pipeline node group. The water flow path refers to a path through which a water flow travels through the water supply pipeline network.

In some embodiments, the water flow path may be a path from a starting point (e.g., a water supply end, etc.) to a branch point (e.g., a pump station, etc.) or an end point (e.g., a water use end, etc.). The water supply pipeline network includes a plurality of water flow paths.

In some embodiments, if there is a relatively large difference between the water flow rates of a plurality of water pipeline nodes on the same water flow path, the government regulation management platform may perform gradient division on the plurality of water flow rates of the plurality of water pipeline nodes to obtain a plurality of flow rate gradients, and classify one or more water pipeline nodes within a same flow rate gradient into a water pipeline node group.

Merely by way of example, a water flow path includes four water pipeline nodes. The water flow rates of the four water pipeline nodes are 100 liters per second (L/s), 80 L/s, 60 L/s, and 40 L/s, respectively. The government regulation management platform may divide the water pipeline nodes corresponding to 100 L/s and 80 L/s into one water pipeline node group based on the flow rate gradient, and divide the water pipeline nodes corresponding to 60 L/s and 40 L/s into another water pipeline node group.

The time-series flow rate corresponding to a water pipeline node group refers to data characterizing the water flow rates corresponding to the water pipeline node group at a plurality of time points. In some embodiments, the time-series flow rate may be represented in the form of a sequence that includes the water flow rate corresponding to the water pipeline node group at each of the plurality of time points. One water pipeline node group corresponds to one time-series flow rate. The plurality of time points may be preset based on historical experience, such as a plurality of time points within a day, etc.

In some embodiments, the government regulation management platform determines the time-series flow rates corresponding to the plurality of water pipeline node groups based on the water flow features of the plurality of water pipeline nodes in the water supply pipeline network. For example, the government regulation management platform may determine an average water flow rate of the plurality of water pipeline nodes within the water pipeline node group at each of the plurality of time points, and designate the average water flow rates corresponding to the plurality of time points as the time-series flow rate corresponding to the water pipeline node group.

Operation 220, determining one or more water and soil loss coefficients corresponding to each of one or more target regions based on the time-series flow rates corresponding to the plurality of water pipeline node groups.

A target region refers to a region in the water supply pipeline network that needs attention. For example, the target region may include a water supply region in the water supply pipeline network corresponding to a neighborhood, a plant, or the like. One target region may include one or more water pipeline node groups. It should be noted that water pipeline nodes within a water pipeline node group are located in a same target region.

The water and soil loss coefficient refers to data that characterizes water and soil loss in the target region. One target region corresponds to one water and soil loss coefficient.

In some embodiments, the government regulation management platform determines, based on the time-series flow rates, the one or more water and soil loss coefficients corresponding to each of the one or more target regions. For example, for a target region among the one or more target regions, the government regulation management platform may determine a time-series flow rate difference between two adjacent water pipeline node groups within the target region, and determine the one or more water and soil loss coefficients corresponding to the target region based on the time-series flow rate difference. If the target region includes more than two water pipeline node groups, the target region may correspond to a plurality of water and soil loss coefficients, and each of the plurality of water and soil loss coefficients corresponds to a set of two adjacent water pipeline node groups. The time-series flow rate difference refers to a sequence consisting of differences in water flow rates between two time-series flow rates at each of the plurality of time points. A difference in water flow rates is also referred to as a water flow rate difference.

In some embodiments, the government regulation management platform may designate two water pipeline node groups as two adjacent water pipeline node groups if an adjacency distance between the two water pipeline node groups is less than a distance threshold. The distance threshold is preset based on historical experience. The adjacency distance refers to a distance between two water pipeline node groups. The adjacency distance may be expressed by a straight line distance between two physical center points corresponding to the two water pipeline node groups. The physical center point of a water pipeline node group may include a midpoint of one or more pipelines within the water pipeline node group, etc.

In some embodiments, for each set of two adjacent water pipeline node groups, the government regulation management platform may, based on the time-series flow rate difference between the two water pipeline node groups, identify time points corresponding to water flow rate differences in the time-series flow rate difference that are greater than a first difference threshold as target time points, and determine the water and soil loss coefficient corresponding to the set of two adjacent water pipeline node groups based on the target time points and the water flow rate differences corresponding to the target time points. The first difference threshold may be preset based on historical experience.

By way of example, the water and soil loss coefficient may be positively correlated to a count of the target time points and an average of the water flow rate differences corresponding to the target time points, and negatively correlated to a total count of the plurality of time points corresponding to the time-series flow rate difference. The government regulation management platform may determine the water and soil loss coefficient by using Equation (1):

$$S = k * ( m / M ) * g , \qquad ( 1 )$$

wherein S denotes the water and soil loss coefficient, k denotes a trend of flow rate difference, m denotes the count of the target time points, M denotes the total count of the time points corresponding to the time-series flow rate difference, and g denotes the average of the water flow rate difference corresponding to the target time points.

The trend of flow rate difference refers to data characterizes the change of the water flow rate differences corresponding to the target time points. In some embodiments, the government regulation management platform may obtain a linear function based on the target time points and the water flow rate differences corresponding to the target time points by linear fitting or the like, and designate a slope of the obtained linear function as the trend of flow rate difference. A horizontal axis of the linear function represent the target time points, and a vertical axis of the linear function represent the water flow rate differences corresponding to the target time points.

Operation 230, generating, based on the one or more water and soil loss coefficients, a temporary control parameter through a parameter generation model.

In some embodiments, the parameter generation model (also referred to as a parameter generation large model) is a machine learning model. For example, the parameter generation model may include a Graph Neural Network (GNN) model, a large model, a customized model structure, or the like, or any combination thereof. An input of the parameter generation model includes the water and soil loss coefficient(s) corresponding to the one or more target regions, and an output of the parameter generation model includes the temporary control parameter.

The temporary control parameter refers to a parameter used to control an adjustment device (e.g., a valve, etc.) in the water supply pipeline network. In some embodiments, the temporary control parameter includes an opening level of each of one or more valves in the one or more target regions. It may be understood that the temporary control parameter is used to control the adjustment device over a period, and that a new temporary control parameter may be determined subsequently.

In some embodiments, a magnitude of the opening level of a valve corresponds to a magnitude of the water flow rate at the valve. The larger the opening level corresponding to a water pipeline node located upstream of the target region, the larger the water flow rate into the target region. The larger the opening level of the valve corresponding to a water pipeline node group, the larger the water flow rate into the water pipeline node group.

In some embodiments, the temporary control parameter output by the parameter generation model may include opening levels of a portion of the valves in the target region, etc. The parameter generation model may determine one or more sets of adjacent water pipeline node groups whose opening levels need to be adjusted based on at least one of the one or more water and soil loss coefficients corresponding to the target region and output the opening levels of the valves corresponding to the water pipeline node groups whose opening levels need to be adjusted.

In some embodiments, the parameter generation model is obtained by training a first set of training samples. In some embodiments, the first set of training samples includes a plurality of first training samples with first labels. The first training samples include sample water and soil loss coefficients corresponding to one or more target regions, and the first labels include historical control parameters for the one or more target regions. The historical control parameters refer to temporary control parameters adopted during a historical time period.

In some embodiments, the government regulation management platform determines the first training samples and the first labels based on historical data. For example, the government regulation management platform may, based on the historical data, take a historical control parameter in the historical data that demonstrates a relatively good regulation effect during a second historical time period as the first label, and take historical loss coefficient(s) of the one or more target regions corresponding to the first label during a first historical time period as the first training sample. In some embodiments, if a decrease in the water and soil loss coefficient(s) of the one or more target regions exceeds a magnitude threshold after the government regulation management platform regulates the adjustment device based on the historical control parameter, the government regulation management platform determines that the historical control parameter has a relatively good regulation effect. The magnitude threshold is preset based on historical experience. The historical loss coefficient refers to a water and soil loss coefficient from the historical data. The first historical time period precedes the second historical time period.

In some embodiments, the government regulation management platform may input the plurality of first training samples with the first labels into an initial parameter generation model, construct a loss function based on the first labels and output results of the initial parameter generation model, and based on the loss function, iteratively update the parameters of the initial parameter generation model through a gradient descent technique, or the like. When the loss function satisfies a preset condition, the trained parameter generation model is obtained. In some embodiments, the preset condition may include the loss function converging, a count of the iterations reaching a threshold, or the like.

In some embodiments, the temporary control parameter may further include output power and an on/off parameter. The government regulation management platform may control an operation of a water supply pump based on the output power, and control an operation of a user device based on the on/off parameter. More descriptions regarding the water supply pump and the user device may be found in FIG. 1 and the relevant descriptions thereof.

The output power refers to an output power level of the water supply pump. The on/off parameter refers to a parameter that controls an opening/closing status of the user device. The water supply pump may supply water to the one or more target regions.

In some embodiments, the government regulation management platform may determine the output power and the on/off parameter based on the water and soil loss coefficient(s) corresponding to the one or more target regions. For example, if the water and soil loss coefficient(s) of the one or more target regions corresponding to the water supply pump are greater than a first threshold, the government regulation management platform may reduce the output power of the water supply pump. The greater a difference value between the water and soil loss coefficient and the first threshold, the lower the output power is. The water and soil loss coefficients corresponding to the one or more target regions may be represented by an average value of the water and soil loss coefficients.

As another example, if the one or more water and soil loss coefficients of the one or more target regions are greater than a second threshold, the government regulation management platform may determine the on/off parameter of the user device corresponding to the target region to be off.

In some embodiments, the government regulation management platform sends the output power and the on/off parameter to the water company management platform via the government regulation sensing network platform, and the water company management platform sends the output power and the on/off parameter to the smart water device object platform through the water company sensing network platform. Based on the output power and the on/off parameter, the smart water device object platform designates the output power in the temporary control parameter as the output power of the water supply pump, and based on the on/off parameter, controls the opening/closing status of the user device.

According to some embodiments in the present disclosure, the water pressure in the water supply pipeline network can be balanced by adjusting the output power of the water supply pump. In addition, non-essential water usage can be limited by shutting off the user device, thereby reducing the load of the water supply pipeline network, and further reducing the risk of the water and soil loss.

Operation 240, controlling an opening level of each of one or more valves corresponding to the one or more target regions based on the temporary control parameter.

In some embodiments, the each of one or more valves corresponding to the one or more target regions may include a valve corresponding to a water pipeline node located upstream of the target region, etc. The greater the opening level of the valve corresponding to the water pipeline node located upstream of the target region, the greater the water flow rate into the target region.

In some embodiments, the one or more valves corresponding to the one or more target regions may further include valves corresponding to a portion of the water pipeline node groups within the target region, etc. The larger the opening levels of the valves corresponding to the portion of the water pipeline node groups within the target region are, the greater the water flow rate into the water pipeline node groups is.

In some embodiments, the government regulation management platform may determine a target valve based on the temporary control parameter and adjust an opening level of the target valve based on the temporary control parameter, thereby regulating the water flow rate for the entire target region or one or more water pipeline node groups within the target region. The target valve refers to a valve whose opening degree requires adjustment.

According to some embodiments of the present disclosure, real-time monitoring and smart control of the water supply pipeline network can be realized by analyzing the time-series flow rates of the plurality of water pipeline node groups, determining the one or more water and soil loss coefficients of each of the one or more target regions, and then determining the control parameter of the adjustment device. This approach improves the monitoring accuracy, the response speed, and the operation efficiency, and reduces the water and soil loss and the water resource wastage, thereby providing effective technical support for the water pipeline management in the smart cities.

It should be noted that the foregoing description of process 200 is intended to be exemplary and illustrative only and does not limit the scope of application of the present disclosure. For a person skilled in the art, various corrections and changes can be made to process 200 under the guidance of the present disclosure. However, these corrections and changes remain within the scope of the present disclosure.

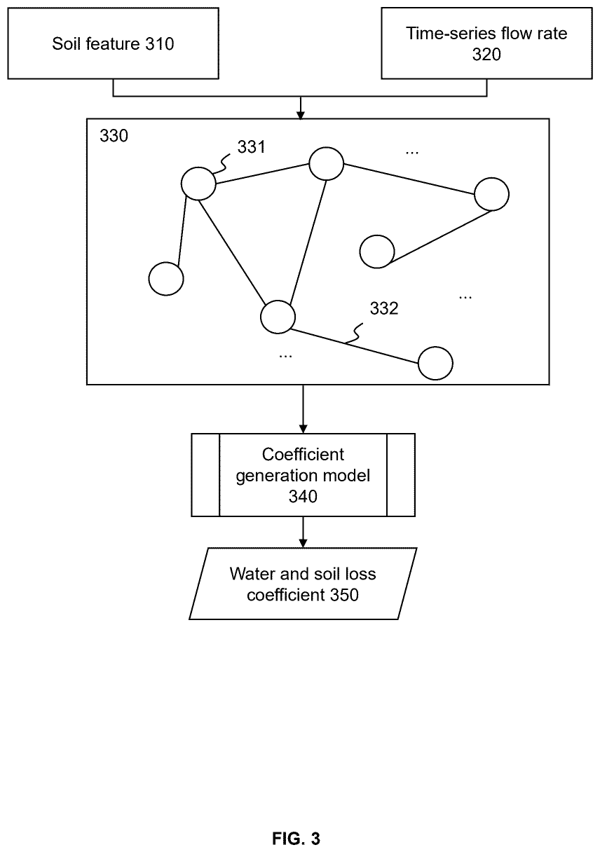

FIG. 3 is a schematic diagram illustrating an exemplary coefficient generation model according to some embodiments of the present disclosure.

In some embodiments, the smart water device object platform 150 further includes a detection robot. The government regulation management platform 110 may collect a soil feature 310 of each of water pipeline node groups in each of one or more target regions via the detection robot, construct a water and soil loss map 330 based on the soil features 310 and time-series flow rates 320, and determine one or more water and soil loss coefficients 350 corresponding to a target region through a coefficient generation model 340 based on the water and soil loss map 330. More descriptions regarding the detection robot, the water pipeline node groups, the time-series flow rates, the target region, and the water and soil loss coefficient may be found elsewhere in the present disclosure (e.g., descriptions relating to FIG. 4).

The soil feature of a water pipeline node group refers to data related to the soil at the location of the water pipeline node group. In some embodiments, the soil feature may include at least one of soil density, soil water content, soil viscosity, etc.

The water and soil loss map refers to a map structure that characterizes water and soil loss in the water supply pipeline network. In some embodiments, the government regulation management platform may construct the water and soil loss map based on the soil features and the time-series flow rates of the water pipeline node groups in one or more target regions. In some embodiments, a main structure of the water and soil loss map is determined based on the structure of the water supply pipeline network. The water and soil loss map includes a plurality of nodes (e.g., a node 331, etc.) and a plurality of edges (e.g., an edge 332, etc.).

In some embodiments, the government regulation management platform designates a water pipeline node group in the target region as a node, and an edge exists between two neighboring water pipeline node groups. A node feature of each of the plurality of nodes may include the target region to which the water pipeline node group corresponding to the node belongs, the soil feature of the water pipeline node group corresponding to the node, etc. An edge feature of each of the plurality of edges may include a direction of water flow between the nodes connected by the edge, an adjacency distance between the nodes connected by the edge, and a time-series flow rate difference between the two nodes connected by the edge, etc. More descriptions regarding the adjacent water pipeline node groups, the adjacency distance, and the time-series flow rate difference may be found in FIG. 2 and the relevant descriptions thereof.

In some embodiments, the node feature of each of the plurality of nodes further includes one or more node-hotspot offsets of the node.

The node hotspot offset of a node refers to a distance between the node and a corresponding target control hotspot. More descriptions regarding a control hotspot may be found in FIG. 4 and the relevant descriptions.

In some embodiments, one node may correspond to one or more target control hotspots. The government regulation management platform may determine the target control hotspot based on a location of the node in relation to a location of a control hotspot identified during a previous determination of the temporary control parameter. For example, the government regulation management platform may determine a distance between the node and each of a plurality of control hotspots determined during the previous determination of the temporary control parameter, determine one or more control hotspots whose distances with the bode are less than a node distance threshold as the one or more target control hotspots corresponding to the node, and determine a distance between the node and each of the one or more target control hotspots to obtain one or more node hotspot offsets of the node. The node distance threshold may be preset based on historical experience.

In some embodiments, incorporating the node hotspot offset into the node feature provides valuable information from the perspective of spatial distribution and regulation effect, which facilitate the determination of a more comprehensive water and soil loss map, thus improving the accuracy of the determination of the water and soil loss coefficient.

In some embodiments, the node feature may further include a detection parameter of the detection robot.

The detection parameter refers to a parameter related to sampling conducted by the detection robot. In some embodiments, the detection parameter includes sampling volumes, sampling depths, or the like at different water pipeline node groups. The sampling depth of a water pipeline node group may be a depth of the soil sampled by the detection robot at the water pipeline node group. The government regulation management platform may incorporate the sampling volume, the sampling depth, etc., corresponding to a water pipeline node group as the node feature of the node corresponding to the water pipeline node group.

In some embodiments, the detection parameter of the detection robot can reflect the reliability of the soil feature, which makes the water and soil loss map more informative, and thus improves the accuracy of the determination of the water and soil loss coefficient.

In some embodiments, the water and soil loss map may include at least one key edge. An edge feature of the at least one key edge includes a loss correlation coefficient.

A key edge refers to an edge to be focused on in the water and soil loss map. In some embodiments, the at least one key edge may be preset based on historical experience.

In some embodiments, the government regulation management platform may determine each of the at least one key edge based on a time-series flow rate difference of two nodes connected by the edge in the water and soil loss map.

In some embodiments, the government regulation management platform may identify an edge in the water and soil loss map as the key edge if the time-series flow rate difference between the two nodes connected by the edge is greater than a second difference threshold. The second difference threshold may be preset based on historical experience.

In some embodiments, an edge with a relatively large time-series flow rate difference is more reflective of dynamic changes in water and soil loss. Determining the at least one key edge in the water and soil loss map can provide more information for determining the water and soil loss coefficient.

The loss correlation coefficient refers to a coefficient that characterizes a correlation of water and soil loss between water pipeline node groups. In some embodiments, the government regulation management platform may determine, based on historical data, the loss correlation coefficient corresponding to each of the at least one key edge through correlation analysis, etc. For example, for a key edge among the at least one key edge, the government regulation management platform may obtain historical loss coefficients corresponding to nodes connected by the key edge at a plurality of historical time points, and determine the loss correlation coefficient corresponding to the key edge by performing data preprocessing on the obtained data. The data preprocessing may include cleaning, denoising, filling in missing values, unifying time scales and spatial resolutions, normalization, temporal alignment, or the like. The plurality of historical time points may be preset based on historical experience. The historical loss coefficients refer to water and soil loss coefficients from the historical data.

In some embodiments, the government regulation management platform may determine the loss correlation coefficient corresponding to the key edge based on Equation (2):

$$P = cos ( ( x 1 , … , xn ) , ( y 1 , … , yn ) ) , \qquad ( 2 )$$

wherein P denotes the loss correlation coefficient corresponding to the key edge, x1 denotes a historical loss coefficient for a water pipeline node group x at a historical time point 1, y1 denotes a historical loss coefficient for a water pipeline node group y at the historical time point 1, xn denotes a historical loss coefficient for a water pipeline node group x at a historical time point n, and yn denotes a historical loss coefficient for a water pipeline node group y at the historical time point n. In some embodiments, the water pipeline node group x and the water pipeline node group y are two nodes connected by the key edge.

In some embodiments of this disclosure, setting the at least one key edge reduces computational workload while maintaining sufficient information integrity. Since target regions do not exist in isolation, considering the relation of water and soil loss between the nodes enables better integration of surrounding influencing factors for each target region, thereby improving the accuracy of soil erosion coefficient determination.

In some embodiments, the coefficient generation model (also referred to as a coefficient generation large model) may be a machine learning model. For example, the coefficient generation model may be a Graph Neural Network (GNN) model, a large model, a customized model structures, or the like, or any combination thereof.

In some embodiments, an input of the coefficient generation model includes the water and soil loss map, and an output of the coefficient generation model includes the water and soil loss coefficient corresponding to each of the nodes in the water and soil loss map.

In some embodiments, the coefficient generation model is obtained by training a second training sample set. The second training sample set includes a plurality of second training samples with second labels. The second training sample include a sample water and soil loss map, and the second label includes an actual water and soil loss coefficient corresponding to each node in the sample water and soil loss map.

In some embodiments, the second training samples may be obtained based on historical data, and the second labels may be obtained by manual labeling. For example, the government regulation management platform may designate the water and soil loss map during a third historical time period in the historical data as a second training sample, and the actual water and soil loss coefficient corresponding to each node during a fourth historical time period as the second label. A technician may collect and obtain the actual water and soil loss coefficient through artificial rainfall simulation manners, or the like. The third historical time precedes the fourth historical time.

In some embodiments, a training process of the coefficient generation model is similar to that of the parameter generation model. More descriptions may be found in the related descriptions above.

According to some embodiments of the present disclosure, the automatic collection of the soil feature using the detection robot not only improves the efficiency and accuracy of data collection but also reduces the reliance on human intervention, thus providing technical support for large-scale water and soil loss monitoring in regions. By integrating the time-series flow rate and the soil feature, combined with a large machine learning model, the water and soil loss coefficient can be determined more accurately and quickly, avoiding assessment bias caused by single-indicator evaluations.

FIG. 4 is a schematic diagram illustrating an exemplary process of generating a temporary control parameter according to some embodiments of the present disclosure.

In some embodiments, the government regulation management platform determines at least one control hotspot 420 based on a pipeline network pressure map 410 and one or more water and soil loss coefficients 350 corresponding to each of one or more target regions, and generates a temporary control parameter 430 based on the at least one control hotspot 420. More descriptions regarding the water and soil loss coefficient and the temporary control parameter may be found in FIG. 2 and the relevant descriptions thereof.

The pipeline network pressure map refers to a statistical map reflecting water pressures in different regions or locations in a water supply pipeline network. In some embodiments, the pipeline network pressure map may be represented by a heat map, etc. For example, the government regulation management platform may, in a structural layout diagram reflecting the water supply pipeline network, indicate the water pressures in different regions or locations in the water supply pipeline network by colors (e.g., a blue color representing a low pressure, a red color representing a high pressure, etc.), and indicate a difference in the water pressures between the different regions or locations by a color gradient to obtain the pipeline network pressure map.

A control hotspot refers to a pipeline node in the pipeline network pressure map that requires or is capable of regulation. A pipeline node in the pipeline network pressure map may be a water pipeline node. More descriptions regarding the water pipeline node may be found in FIG. 4 and the relevant descriptions thereof.

In some embodiments, the government regulation management platform may determine the at least one control hotspot based on the pipeline network pressure map and the one or more water and soil loss coefficients corresponding to each of the one or more target regions. For example, based on the pipeline network pressure map and the water and soil loss coefficient(s), the government regulation management platform identifies the pipeline node corresponding to a high-pressure location in the pipeline network pressure map as a control hotspot, and identifies the pipeline node corresponding to a physical center of the target region whose water and soil loss coefficient(s) are greater than a loss coefficient threshold as a control hotspot. The loss coefficient threshold may be preset based on prior experience. The physical center of the target region may include a centermost region or location in the water supply pipeline network corresponding to the target region, etc.

The high-pressure location in the pipeline network pressure map refers to a region or location in the pipeline network pressure map that has the highest water pressure. For example, the high-pressure location may be a region or location in the pipeline network pressure map that has the darkest red color.

In some embodiments, if the target region corresponds to a plurality of water and soil loss coefficients, the government regulation management platform may determine an average value of the plurality of water and soil loss coefficients, take the average value as the water and soil loss coefficient of the target region, and determine whether the water and soil loss coefficient is greater than the loss coefficient threshold.

In some embodiments, the government regulation management platform may generate the temporary control parameter based on the at least one control hotspot. For example, for the control hotspot identified based on the high-pressure location of the pipeline network pressure map, the government regulation management platform may determine the temporary control parameter (i.e., an opening level of a valve of the pipeline corresponding to the control hotspot, etc.) corresponding to the control hotspot by querying a preset parameter table based on the water pressure corresponding to the control hotspot. For the control hotspot determined based on the water and soil loss coefficient(s) of the target region, the government regulation management platform may determine the temporary control parameter corresponding to the control hotspot through a parameter generation model. For the description of the parameter generation model, see FIG. 2 and its related contents.

In some embodiments, the parameter preset table may include a plurality of water pressures and a temporary control parameter corresponding to each of the plurality of water pressures, and may be constructed based on prior experience.

In some embodiments, the government regulation management platform determines one or more highly sensitive regions in the pipeline network pressure map based on a plurality of historical pressure maps and a plurality of historical loss coefficients in a predetermined historical time period, and determines the at least one control hotspot based on the one or more highly sensitive regions and the water and soil loss coefficient(s) corresponding to the one or more target regions.

In some embodiments, the predetermined historical time period may be a time period before a current time point. The predetermined historical time period may be preset based on historical experience and include a plurality of historical time points.

A historical pressure map refers to a pipeline network pressure map in the historical data. The historical pressure map includes historical water pressures, etc., corresponding to the one or more target regions at the plurality of historical time points. A historical loss coefficient refers to a water and soil loss coefficient corresponding to the target region in the historical data.

In some embodiments, one historical time point may correspond to one historical pressure map and the historical loss coefficient(s) corresponding to the one or more target regions at the historical time point.

A highly sensitive region refers to a region in the pipeline network pressure map where the water and soil loss coefficient is highly sensitive to water pressure.

In some embodiments, for each of the one or more target regions, the government regulation management platform may determine a plurality of historical water pressures of the target region based on historical pressure maps corresponding to the plurality of historical time points, and determine a water pressure fluctuation based on the plurality of historical water pressures. The government regulation management platform may further determine a coefficient fluctuation of the target region based on the historical loss coefficients corresponding to the plurality of historical time points. The coefficient fluctuation may reflect a change in the historical loss coefficients.

In some embodiments, the pressure fluctuation may be represented by a difference between historical water pressures at two adjacent historical time points. The coefficient fluctuation may be represented by a difference between historical loss coefficients at two adjacent historical time points.

In some embodiments, in response to the pressure fluctuation of the target region being less than a pressure fluctuation threshold and the coefficient fluctuation of the target region being greater than a coefficient fluctuation threshold, the government regulation management platform determines the target region as a highly sensitive region. The pressure fluctuation threshold and the coefficient fluctuation threshold may be preset based on prior experience.

In some embodiments, the government regulation management platform may determine the at least one control hotspot based on the one or more highly sensitive regions and the water and soil loss coefficient(s) corresponding to the one or more target regions. For example, the government regulation management platform may identify a high-pressure location of each of the one or more highly sensitive region as a control hotspot, and a pipeline node corresponding to the physical center of the target region whose water and soil loss coefficient(s) are greater than the loss coefficient threshold as a control hotspot. The high-pressure location of the highly sensitive region indicates the region or location with the highest water pressure in the highly sensitive region. For example, the high-pressure location of the highly sensitive region may be the region or location with the darkest red color in the highly sensitive region.

In some embodiments, for the control hotspot identified based on the high-pressure location in a highly sensitive region, the government regulation management platform may determine the temporary control parameter corresponding to the control hotspot based on the water pressure corresponding to the control hotspot by querying the preset parameter table.

According to some embodiments of the present disclosure, by determining the one or more highly sensitive region in the pipeline network pressure map based on the historical pressure maps and the historical loss coefficients, regions of possible leakage hazards can be determined in advance, thereby improving the timeliness of early warning of risks. By determining the at least one control hotspot and the temporary control parameter corresponding to each of the at least one control hotspot based on the one or more highly sensitive regions and the one or more water and soil loss coefficients, early prevention of regions that are more likely to be at risk of water and soil loss can be performed.

According to some embodiments of the present disclosure, by determining the at least one control hotspot and the temporary control parameter corresponding to each of the at least one control hotspot at the same time based on the pipeline network pressure map and the water and soil loss coefficient(s), preventive measures can be taken for the regions where the risk of water and soil loss is more likely to occur. The temporary control parameters are generated in a differentiated manner, thereby avoiding energy waste due to global adjustment.

Embodiments of the present disclosure further provide a non-transitory computer-readable storage medium storing computer instructions. When reading the computer instructions in the storage medium, a computer executes the method for emergency regulation of a water supply pipeline network in a smart city described in the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment,” “one embodiment,” or “an alternative embodiment” in various portions of the present disclosure are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be appreciated that in the foregoing description of embodiments of the present disclosure, various features are sometimes grouped together in a single embodiment, figure, or description thereof to streamline the disclosure aiding in the understanding of one or more of the various inventive embodiments. This method of disclosure, however, is not to be interpreted as reflecting an intention that the claimed object matter requires more features than are expressly recited in each claim. Rather, inventive embodiments lie in less than all features of a single foregoing disclosed embodiment.

In some embodiments, the numbers expressing quantities, properties, and so forth, used to describe and claim certain embodiments of the application are to be understood as being modified in some instances by the term “about,” “approximate,” or “substantially.” For example, “about,” “approximate” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A large model-based system of internet of things (IoT) for emergency regulation of a water supply pipeline network in a smart city, comprising a government regulation management platform, a government regulation sensing network platform, a government regulation object platform, a water company sensing network platform, a smart water device object platform, wherein
the government regulation object platform includes a water company management platform;
the smart water device object platform includes a monitoring device and at least one adjustment device;
the government regulation management platform is configured to:
determine a time-series flow rate corresponding to each of a plurality of water pipeline node groups based on water flow features of a plurality of water pipeline nodes in the water supply pipeline network;
determine one or more water and soil loss coefficients corresponding to each of one or more target regions based on the time-series flow rates;
generate, based on the one or more water and soil loss coefficients, a temporary control parameter through a parameter generation model, the parameter generation model being a machine learning model; and
control an opening level of each of one or more valves corresponding to the one or more target regions based on the temporary control parameter.

2. The system of claim 1, wherein the smart water device object platform further includes a detection robot, and the government regulation management platform is further configured to:
collect a soil feature of each of the water pipeline node groups in each of the one or more target regions via the detection robot;
construct a water and soil loss map based on the soil features and the time-series flow rates, wherein the water and soil loss map includes a plurality of nodes and a plurality of edges; and
determine the one or more water and soil loss coefficients through a coefficient generation model based on the water and soil loss map, the coefficient generation model being a machine learning model.

3. The system of claim 2, wherein a node feature of each of the plurality of nodes includes one or more node-hotspot offsets of the node, and each of the one or more node hotspot offsets is a distance between the node and a target control hotspot.

4. The system of claim 2, wherein a node feature of each of the plurality of nodes includes a detection parameter of the detection robot.

5. The system of claim 2, wherein the water and soil loss map includes at least one key edge, and an edge feature of the at least one key edge includes a loss correlation coefficient.

6. The system of claim 5, wherein each of the at least one key edge is determined based on a time-series flow rate difference between two nodes connected by the edge.

7. The system of claim 1, wherein the government regulation management platform is further configured to:
determine at least one control hotspot based on a pipeline network pressure map and the one or more water and soil loss coefficients; and
generate the temporary control parameter based on the at least one control hotspot.

8. The system of claim 7, wherein the government regulation management platform is further configured to:
determine one or more highly sensitive regions in the pipeline network pressure map based on a plurality of historical pressure maps and a plurality of historical loss coefficients in a predetermined historical time period; and
determine the at least one control hotspot based on the one or more highly sensitive regions and the one or more water and soil loss coefficients.

9. The system of claim 1, wherein the temporary control parameter includes output power and an on/off parameter, and the government regulation management platform is further configured to:
control an operation of a water supply pump based on the output power; and
control an operation of a user device based on the on/off parameter.

10. A method for emergency regulation of a water supply pipeline network in a smart city, executed by a government regulation management platform of a large model based system of internet of things (IoT) for emergency regulation of the water supply pipeline network in the smart city, the system comprising a government regulation management platform, a government regulation sensing network platform, a government regulation object platform, a water company sensing network platform, a smart water device object platform, wherein
the government regulation object platform includes a water company management platform;
the smart water device object platform includes a monitoring device and at least one adjustment device;
the method comprising:
determining a time-series flow rate corresponding to each of a plurality of water pipeline node groups based on water flow features of a plurality of water pipeline nodes in the water supply pipeline network;
determining one or more water and soil loss coefficients corresponding to each of one or more target regions based on the time-series flow rates;
generating, based on the one or more water and soil loss coefficients, a temporary control parameter through a parameter generation model, the parameter generation model being a machine learning model; and
controlling an opening level of each of one or more valves corresponding to the one or more target regions based on the temporary control parameter.

11. The method of claim 10, wherein the smart water device object platform further includes a detection robot, the determining one or more soil erosion coefficients corresponding to each of one or more target regions based on the time-series flow rates includes:
collecting a soil feature of each of the water pipeline node groups in each of the one or more target regions via the detection robot;
constructing a water and soil loss map based on the soil features and the time-series flow rates, wherein the water and soil loss map includes a plurality of nodes and a plurality of edges; and
determining the one or more water and soil loss coefficients through a coefficient generation model based on the water and soil loss map, the coefficient generation model being a machine learning model.

12. The method of claim 11, wherein a node feature of each of the plurality of nodes includes a node-hotspot offset of the node, and the node hotspot offset is a distance between the node and a target control hotspot.

13. The method of claim 11, wherein a node feature of each of the plurality of nodes includes a detection parameter of the detection robot.

14. The method of claim 11, wherein the water and soil loss map includes at least one key edge, and an edge feature of the at least one key edge includes a loss correlation coefficient.

15. The method of claim 14, wherein each of the at least one key edge is determined based on a time-series flow rate difference between two nodes connected to the edge.

16. The method of claim 10, further comprising:
determining at least one control hotspot based on a pipeline network pressure map and the water and soil loss coefficient; and
generating the temporary control parameter based on the at least one control hotspot.

17. The method of claim 16, further comprising:
determining one or more highly sensitive regions in the pipeline network pressure map based on a plurality of historical pressure maps and a plurality of historical loss coefficients in a predetermined historical time period; and
determining the at least one control hotspot based on the one or more highly sensitive regions and the water and soil loss coefficient.

18. The method of claim 10, wherein the temporary control parameter includes output power and an on/off parameter, and the method further comprises:
controlling an operation of a water supply pump based on the output power; and
controlling an operation of a user device based on the on/off parameter.
